(19) United States
(12) Patent Application Publication
(10) Pub. No.: US 2005/0282117 A1
(43) Pub. Date: Dec. 22, 2005

(54) Systems and methods for dispensing sealant in medical applications

(76) Inventors: Ines M. Aravena, Camarillo, CA (US); Matthew Saccomanno III, Oceanside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/122,771

(22) Filed: May 5, 2005

Related U.S. Application Data
(60) Provisional application No. 60/568,471, filed on May 5, 2004.
(60) Provisional application No. 60/583,916, filed on Jun. 29, 2004.

(51) Int. Cl. A61C 5/02; A61C 5/04

(52) U.S. Cl. 433/224; 433/81; 433/90

(57) ABSTRACT

A method for preparing and inserting a sealant into a root canal includes the method activating an un-activated sealant while it is positioned at least partially within an elongated tubular body having a distal end configured to fit within the root canal. The distal end of elongated tubular body is inserted into the target cavity. A plunger is then advanced through the elongated tubular body to disperse the activated sealant into the root canal.

### PRIORITY INFORMATION

The present invention claims the priority benefit of U.S. Provisional App. No. 60/568,471, filed May 5, 2004 and U.S. Provisional App. No. 60/583,916, filed Jun. 29, 2004, the entire contents of which are hereby incorporated by reference herein.

### BACKGROUND OF THE INVENTION

1. Field of the Invention

The present invention relates to medical applications and, more particularly, to systems and methods for dispensing a sealant in medical applications.

2. Description of the Related Art

Underneath a tooth's outer enamel and within the dentin is an area of soft tissue called the pulp, which carries the tooth's nerves, veins, arteries and lymph vessels. Root canals are very small, thin divisions that branch off from the top pulp chamber down to the tip of the root. A tooth has at least one but no more than four root canals.

Endodontic treatment is sometimes necessary when the pulp, becomes inflamed or infected. The inflammation or infection can have a variety of causes: deep decay, repeated dental procedures on the tooth, or a crack or chip in the tooth. In addition, an injury to a tooth may cause pulp damage even if the tooth has no visible chips or cracks. If pulp inflammation or infection is left untreated, it can cause pain or lead to an abscess.

A root canal is a procedure done to save the damaged or dead pulp in the root canal of the tooth by cleaning out the diseased pulp and reshaping the canal. Such procedures typically involve exposing of the apical end of the tooth and removing the inflamed or infected pulp. The inside of the cannel may be cleaned and shaped. The canal is then filled to seal the space. A crown or other restoration is placed on the tooth to protect and restore it to full function. After restoration, the tooth is fully functional.

The lack of an adequate seal at the apical-end of the tooth is the most common cause of root canal failures because bacteria can leak inside the root canal along with saliva. Current methods used for mixing and delivery of the sealant (e.g., a cement) to repair perforations or to seal off the pathways of communication between the root canal system and the external surface of the tooth are cumbersome, time consuming, and inaccurate. The present tools used to mix and place the cement materials require the need to have a consistency of the mixture that is too dense for its application and in many cases the perforated root-end does not get completely filled, which causes adverse effects. The need to offer a method that allows for adequate solubility of the cement mixture while improving its handling and placement can further facilitate the process of repairing perforations accurately to maintain the vitality of the pulp status of the a tooth.

### SUMMARY OF THE INVENTION

Accordingly, one embodiment of the present invention comprises a method for preparing and inserting a sealant into a root canal. An un-activated sealant is activated while it is positioned at least partially within an elongated tubular body having a distal end configured to fit within the root canal. The distal end of elongated tubular body is inserted into the target cavity. A plunger is then advanced through the elongated tubular body to disperse the activated sealant into the root canal.

Another embodiment of the present invention involves a method for preparing and inserting a sealant into a lumen within a patient. A carrier is provided. The carrier defines a lumen having a first end and a second end and includes an un-activated sealant positioned within the lumen. The first end of the carrier is inserted into a container containing an activating solution. The first end of the carrier is left in the container for a first period of time that is sufficient to activate a first portion of the sealant while a second portion of the sealant remains un-activated. The first portion of the sealant is nearer the first end of the carrier as compared to the second portion. The carrier is substantially inverted and then maintained in the substantially inverted position for a second period of time that is sufficient to activate the second portion of the sealant.

Another embodiment of the present invention comprises a mechanism for dispensing a hydrated dental cement. The mechanism includes a tubular body that comprises a first open end and a second open end. The tubular body is defined at least in part by a tubular wall that defines a lumen. A push rod is positioned within the tubular body. A dry dental cement is positioned within the tubular body between the push rod and the first open end of the tubular body. A housing is coupled to the second end of the tubular body. The housing is configured to be grasped by a user. The housing further comprises an actuating mechanism that is configured advance the push rod through the tubular body to dispense the dental cement from the first open end while keeping the tubular body stationary with respect to the housing.

Another embodiment of the present invention comprises a carrier configured to store and dispense a dental cement into a root canal. The carrier includes a tubular body that comprises a first open end and a second open end. The tubular body is defined at least in part by a tubular wall that defines a lumen and is substantially impermeable to water. A dry dental cement is positioned within the lumen of the tubular body. The carrier further includes means for closing the first open end of the tubular body and means for closing the second open end of the tubular body.

### BRIEF DESCRIPTION OF THE DRAWINGS

FIG. 1 is a cross section view of an exemplary embodiment of a carrier.

FIG. 1A is a side view of another embodiment of a carrier.

FIG. 1B is a cross-sectional view of a distal end of a modified embodiment of a carrier.

FIG. 1C is a perspective view of the carrier of FIG. 1B.

FIG. 1D is a cross-sectional view of the carrier of FIG. 1C with a distal cap.

FIG. 1E is a cross-sectional view of a modified distal cap.

FIG. 1F is a schematic illustration of the carrier of FIG. 1C positioned in a vial adjacent a soak strip.

FIG. 1G is a schematic illustration of a cross-section of a tooth with the carrier of FIG. 1 positioned in the root canal.

FIG. 2 is an exploded view of the syringe dispensing mechanism.

FIG. 3 is an isometric cross section view of an exemplary embodiment of a syringe dispensing mechanism

FIG. 3A is a close up cross section of the exemplary metering features of the mechanism of FIG. 3.

FIG. 4 is a cross section view of a modified embodiment of a dosage control mechanism.

FIG. 4A is a closer view of a portion of the dosage control mechanism of FIG. 4.

FIG. 5 is an isometric exploded view of a exemplary embodiment of a disposable carrier mechanism.

FIG. 5A is a cross section view of the disposable carrier mechanism of FIG. 5.

FIGS. 6 and 6A are an exploded view and a cross-sectional view of an exemplary dispensing mechanism with a mechanical pencil with compression spring device.

FIGS. 7 and 7A are an exploded view and a cross-sectional view of an exemplary dispensing mechanism with a mechanical pencil with compression spring device.

FIGS. 8 and 8A is an isometric view and exploded view of another embodiment of a dispensing mechanism.

FIG. 9 is another embodiment of a dispensing mechanism.

FIG. 10 is a modified embodiment of a portion of the dispensing mechanism of FIG. 9.

FIG. 11 is schematic illustration of another embodiment of a dispensing mechanism.

FIG. 12 is a schematic side view of an exemplary embodiment of a hydration step.

FIG. 13 illustrates the hydration during the hydration step of FIG. 12.

FIG. 14 illustrates the hydration during an exemplary second hydration step.

### DETAILED DESCRIPTION OF THE PREFERRED EMBODIMENT

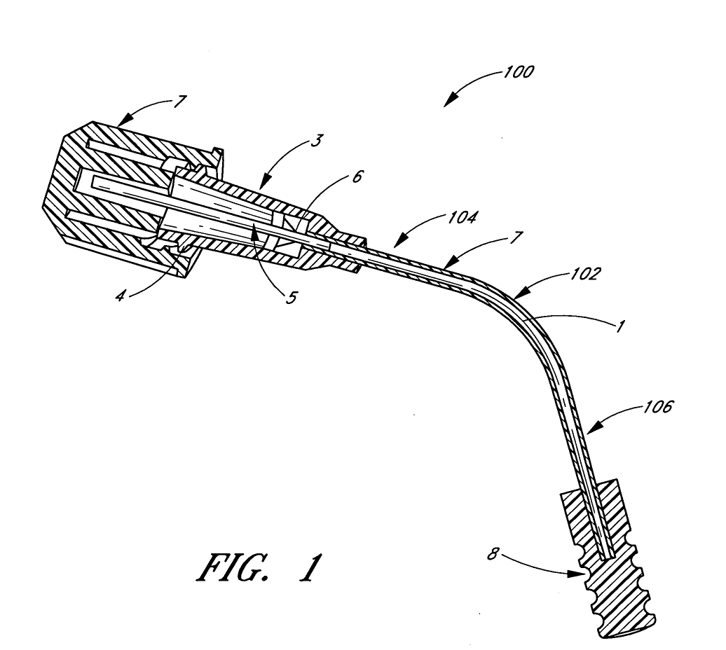

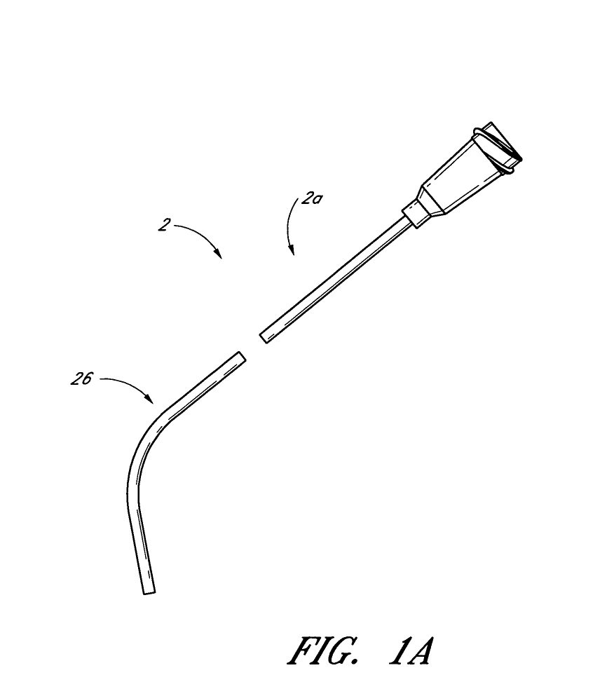

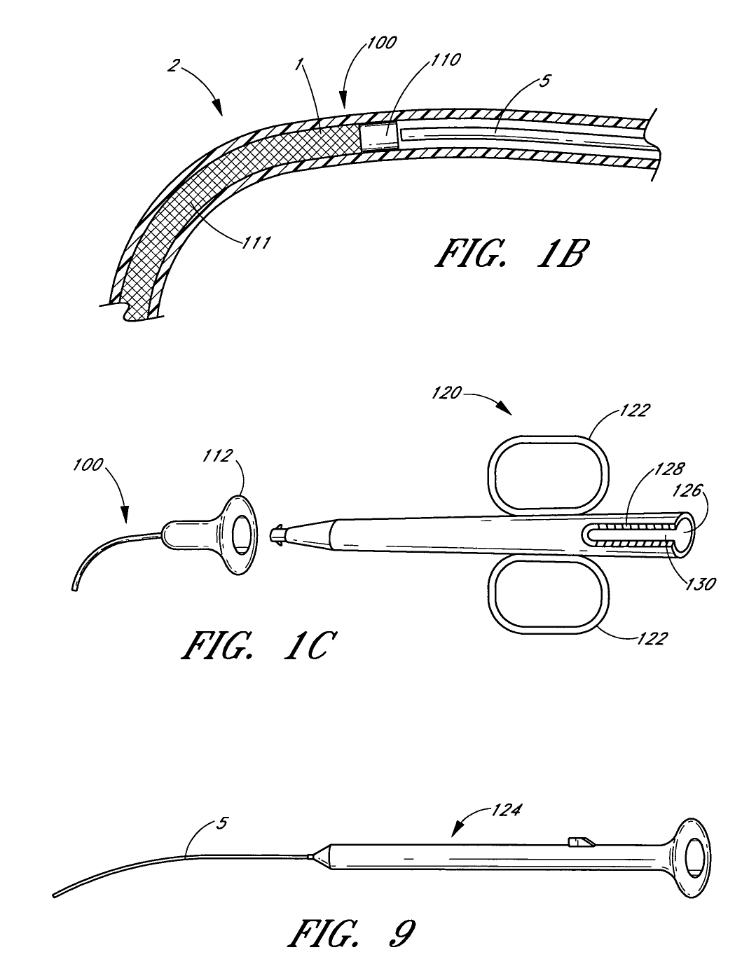

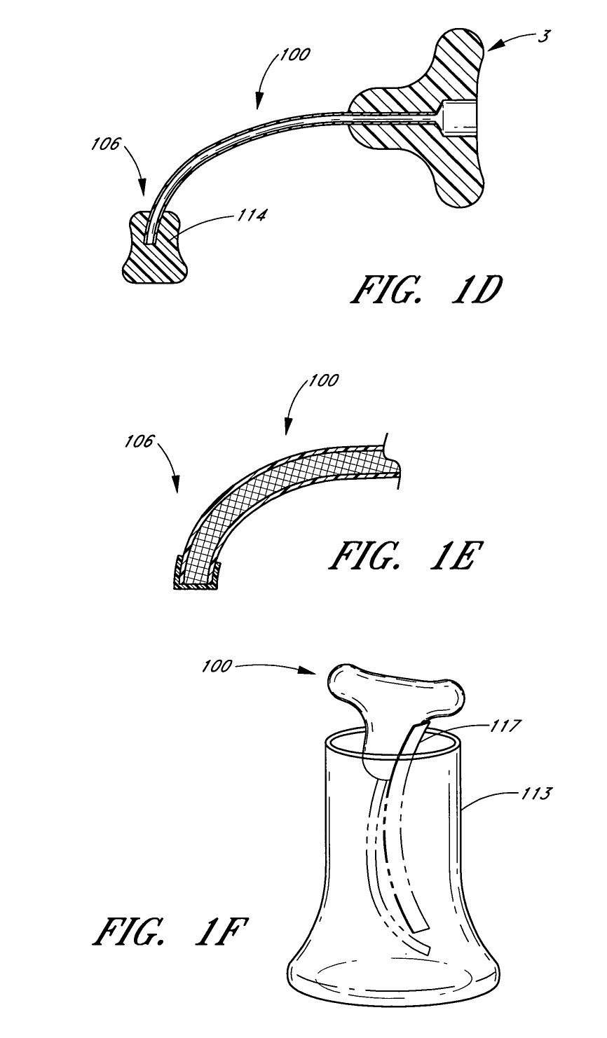

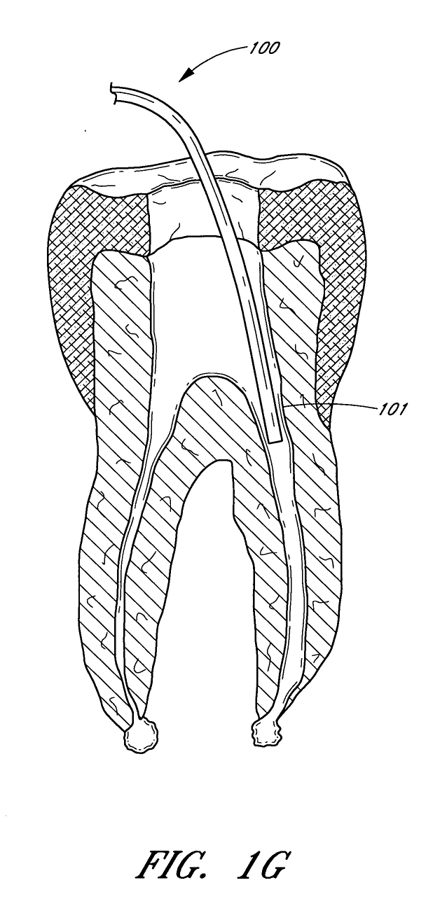

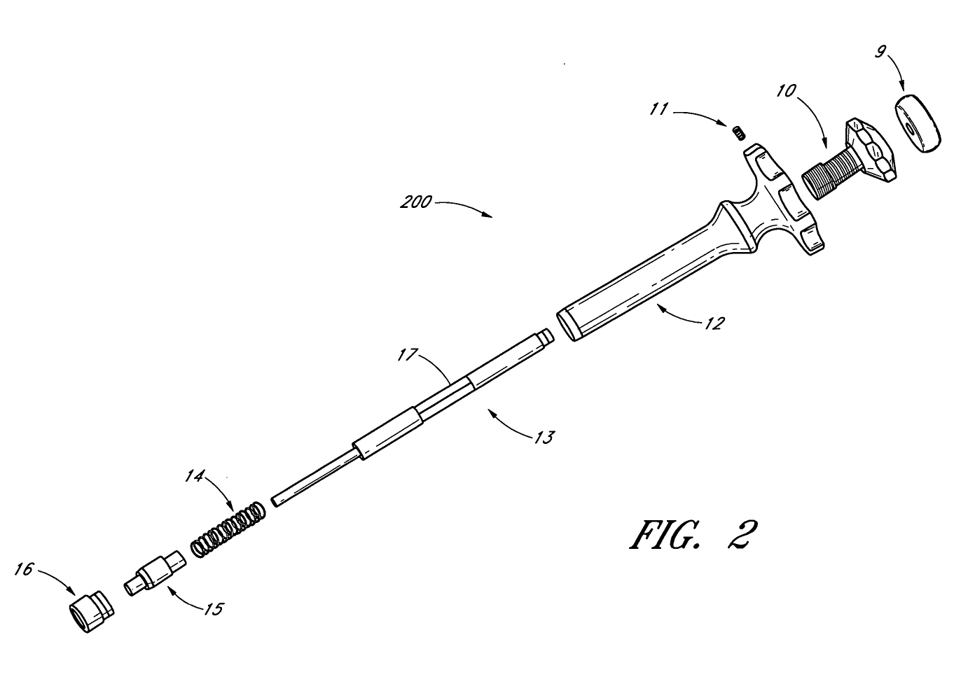

FIG. 1 is a cross section view of an exemplary embodiment of a carrier unit 100. In the preferred embodiment, the carrier unit 100 comprises a tip or carrier 2 which defines a cavity 1. The carrier 2 is at least partially filled with a deactivated sealant, which can be pre-loaded in the cavity 1. As will be explained below, the deactivated sealant is preferably activated while it is in the carrier 2. The deactivated sealant is preferably a dry cement and more preferably mineral trioxide aggregate or “MTA”, which is activated by hydrating the cement while it is within the carrier 2.

In the preferred embodiment, the dry cement is hydrated with water, water vapor or a water containing solution. MTA is preferred because it is a particularly advantageous sealant for root canals and other dental procedure. However, it should be appreciated that in modified embodiments different types of sealants may be used. Such sealants may be activated within the carrier by other components besides water. Accordingly, although the description herein will often refer to “dry cement”, “hydration”, “hydrated”, “water” and “cement”, it should be appreciated that such terms may be interchanged, for example, with “deactivated sealant”, “activation” “activated”, “activating solution” and “sealant”. In addition, in some modified embodiments, the carrier 100 need not deliver a sealant but may be used to deliver therapeutic compounds, such as, for example, pain killers, antibiotics etc., which require the mixing of two or more components. This device 100 can also be used to deliver bone augmentation materials such as bio-oss etc. Such a dry powder is packed in the carrier and is hydrated similar to cement as described below.

The carrier 2 preferably has a shape and size that allows for its distal end to be directly insertion into the target cavity or lumen into which the hydrated cement will be injected. For example, in the preferred embodiment, the carrier 2 is configured for insertion into a root canal 101 as shown in FIG. 1G or other dental sites. Accordingly, the carrier 2 has a generally needle-like shape with or without curved section 102 located between substantially straight proximal 104 and distal sections 106. See FIG. 1. The angled shape of the carrier 2 is particularly advantageous for reaching posterior teeth. However, for teeth located between canine to canine, it is not necessary to have curved section. Of course in modified embodiments, the shape of the carrier 2 may be adjusted (e.g., straight or angled). In one preferred embodiment, the carrier has overall length of about 0.01 inch to 5 inch and a diameter of about 0.003 inch to 1 inch with a radius of curvature of the curved section 102 being about 1 degree to 170 degrees. Those of skill in the art will recognize in light of the disclosure herein how to shape and design the carrier 2 to fit within other target cavities or lumens.

In a modified embodiment, the carrier 2 the carrier 2 is formed from a flexible material such as Nitinol or engineering plastics. As such, the carrier 2 can bend or otherwise modify its shape as it is inserted into the target cavity (e.g., a root canal). In another modified embodiment, the carrier 2 is formed of a material or sized such that it can be bent by hand or with a tool by the user. In this manner, the user can customize the shape of the carrier 2 to fit the specific clinical application. In such an embodiment, the carrier 2 can be formed of a material that is capable of retaining its shape after being bent, such as, for examples certain metals (stainless steel, Titanium, etc) or plastics.

In a preferred embodiment, the carrier 2 is formed from a substantially tubular like member that includes a wall that is substantially impermeable to a hydrating solution (e.g., water). In this manner, this sealant within the cavity 1 is hydrated from the open distal and/or proximal ends of the carrier 2. This embodiment advantageously overcomes the shortcomings of, for example, the carrier device disclosed in U.S. Pat. No. 6,290,503, which requires perforations to hydrate the cement in the large diameter sleeve 22. In addition, the sleeve of the '503 patent is not configured to be inserted into a root canal as in the preferred embodiment of the present invention.

Depending upon the application, the carrier can be made of one piece or multiple pieces. For example, FIG. 1A illustrates a carrier 2 comprising a straight proximal portion 2a and a curved distal portion 2b. The cement may be stored within the straight proximal portion 2a and after hydration the distal portion 2b may be attached the proximal portion 2b. In this manner, the user may be provided with a variety of different shaped distal portions 2b that are configured to fit the same proximal portion 2a.

With reference back to FIG. 1, in the illustrated embodiment, the carrier 2 is coupled to a hub 3, which may include an engaging feature 4 (e.g. a thread, bayonet fitting, etc.) such that the carrier 2 may be coupled to a dispensing device as will be described in more detail below. The engaging feature 4 can be a standard such as lure-lock or a proprietary connection. The carrier 2 and the hub 3 can be made out of a metal, engineering plastic and/or nitinol material. Preferably, the carrier 2 has no perforations on the axial walls. In addition, the carrier 2 and hub 3 can be color coded to differentiate sizes. The distal end 106 may include visual indicia, such as, for example, laser marks and/or grooves to guide the end user to see how far the carrier 2 is inside the root canal. In another embodiment, the carrier 2 may include an external stop (not shown) that engages the tooth to limit the insertion of the carrier 2 into the root canal or other cavity or lumen.

With continued reference to FIG. 1, in the illustrated embodiment, the carrier 2 is packaged with a push rod 5. The push rod 5 is configured to be inserted into the proximal end 104 of the cavity 1 of the carrier 2 and is configured to push the hydrated solution through the carrier 2. As mentioned above, the push rod 5 may be packaged with the carrier 2 as a single unit. The push rod 5 can comprise a solid piece or it can be hollow to assist in its bending capabilities. In such an embodiment, the push rod 5 may provide a seal on the proximal end 104 of the cavity 1. In another embodiment, the push rod 5 can be part of a dispensing device. The push rod 5 is preferably be made out of a material that has good corrosion resistance properties, low coefficient of friction, and has good acoustic properties, for example, metal, nitinol, and/or engineering plastic and/or combinations thereof may be used.

FIG. 1B illustrates a modified embodiment in which a stopper or pellet 110 is positioned in the cavity 1. The stopper 110 is preferably firmly but moveably lodged into the cavity 1 at a predetermined location thereby closing the proximal end 104 of the cavity 1. The push rod 5 may extend into the cavity 1 and may be used to advance the stopper 110 through the cavity to push the cement out of the carrier 2. In this manner, the stopper 110 is used as a piston 5 to force the material out of the carrier 100. The stopper 110 can also hold the sealant 111 in the cavity when the carrier 100 is separated form the push rod 5 and/or dispensing mechanism. In one embodiment, the stopper 110 is made of plastic and/or metal and the push rod 5 is made of a nickel-titanium alloy and/or stainless steel.

With reference back to FIG. 1, the carrier 2 of the illustrated embodiment includes a sleeve 6 to retain and guide the push rod 5 into the cavity 1. The sleeve 6 is optional and it could be part of the hub 3 in a modified embodiment or omitted. Preferably, the sleeve 6 is formed from an elastic material. Once the dry solution is loaded inside the carrier 2, the assembly 100 can be sealed using a front-end cap 8 and a back-end cap 7 that may be coupled to the hub 3. The front-end cap 8 can be made out of hydrophilic or porous material to assist in the hydration process. In modified embodiments, the push rod 4, the sleeve 6, hub 3 and/or the back-end cap 7 or various combinations thereof may be replaced with a end cap coupled to the proximal end of the carrier 2 or the stop 110 of FIG. 1B. As shown in FIG. 1C, the hub 3 may be provided with gripping features 112 with a finger grip-shape to aid the user in holding the carrier 100.

With reference to FIGS. 1D and 1E, other embodiments for sealing the distal end 106 of the carrier are illustrated. FIG. 1D illustrates a fiction fitted plastic cap 114 while FIG. 1E illustrates a water soluble coating 116 placed on the distal end 106 of the carrier 2.

Depending on the sealant, a variety of methods and techniques may be used to load the sealant into the carrier 2. In one embodiment which is particularly advantageous for MTA or a similar dry cement, a sleeve or funnel is press fitted into one end of the carrier 2. The other end is then closed, for example, by inserting the push rod 5, stopper or temporary restraint into the cavity or over the other end. Then, cement and/or MTA is loaded into the funnel while the carrier is held on a vibratory platform. The powder is allowed to drop inside the carrier due to the force of gravity. Preferably, the powder is not compacted. If a push rod 5 is used, it can serve two functions: first, it prevents the powder from coming out of the back end, second, it transmits vibrations from the vibratory table to the carrier which aids in the downward travel of the powder inside the cavity. Since the rod transmits the vibration from the vibratory table to the carrier, it preferably has good acoustic properties. After powder is loaded in the carrier 1, front and rear caps or plugs as described above are placed on the ends of the carrier 2. Other components may be coupled to the carrier 2 and thereafter the carrier and/or the other components may be placed into in a sterile pouch or outer packaging. An alternative method of loading would be to transmit vibrations directly to the rod 5 using a fixture that contacts the rod 5 directly to a vibration source. Another modified method to load the powder into the carrier are involves using vacuum and/or pressure systems that use manual, semiautomatic and/or fully automatic machines and/or fixtures.

Another modified design for the carrier 2 is to have it fabricated it from sheet metal that is formed into a tube, in a manner similar to that commonly used for welded seam tubing. The tube forming occurs progressively, with an interim step having the sheet metal formed into an open cross sectional profile resembling the letter C. While in this interim form, the C like profile provides a longitudinal slot through which powder can be loaded into the carrier. After powder filling, the carrier is further formed into a closed tube. Optionally the carrier wall seam may be welded after powder filling and final forming to the full tube shape. Alternately the C like profile form of the carrier may be an injection molded plastic.

As mentioned above, the sealant is preferably activated within the carrier 2. In one embodiment, the distal cap 8 is removed from the carrier, which is then loaded placed in the vial containing water so as to expose the distal end of the cavity to the water. The carrier is allowed to sit in this vial for at least a few seconds or as long as the end user desires. The water is absorbed by the sealant thereby hydrating the sealant within the carrier 2. In a modified embodiment, the liquid or water can be pre-heated to reduce the hydration time.

In general, when the carrier is placed in the vial, the wetting of particularly MTA is effected by its properties of capillary action. When the carrier filled with MTA is submerged, water soaks up through the MTA in a predictable, progressive manner. During this process, air contained in the dry MTA powder is displaced by the water and expelled Accordingly, when the carrier is being soaked there is preferably an exit path for the air. If there is no exit path, an air bubble may form which can seal the tip and impede further soaking. Accordingly, in a preferred embodiment, one end of the carrier remains above the water level of the vial and is open or capped with an air permeable cap. In this manner, air can escape from the carrier as the MTA is hydrated. In another embodiment, both ends of the carrier are permeable to air and both ends are submerged into the water. In such an arrangement, bubbles may escape from the multiple exit paths. However, back pressure of the bubbles due to surface tension effects may impede hydration.

The carrier 100 may be soaked for a predetermined amount of time. In another embodiment as shown in FIG. 1F, a wick like 117 material may be inserted into the vial 115 with the carrier 100. The wick-like material 117 can include visual idica (e.g., color changes) to indicate when it is saturated with water. The wick-like material 117 may be chosen such that its saturation time is similar or greater than the saturation time of the cement within the carrier 100.

In another embodiment, the carrier 100 includes dual chambers separated by removable partition or divider positioned in the cavity 1. One chamber contains liquid and the other contains pre-loaded powder only, and a partition and/or divider separates the chambers. At the time of usage, the user removes the divider that separates the two chambers and this allows the liquid to flow in the chamber that contains the dry powder. This in turn hydrates the powder. In one embodiment, the divider is removed by pulling the partition from the cavity. In another embodiment, the effectiveness of the divider is reduced or eliminated, such as, for example, opening slots or holes in the divider.

In another embodiment, a dropper is used to add drops of water from the back end of the carrier 100 after removing pin 5 and cap 7. The water enters through the sleeve 6 and progressively wets the cement. The carrier 100 is preferably orientated such that gravity causes water to move down the carrier to cause the dry powder to become wet. This can be further aided by placing the carrier 100 in water filled vial. After the water is added, the pin 5 is replaced.

Another embodiment for activating the sealant, comprises opening the proximal and/or distal ends of the cavity 1 and exposing them to a steam chamber. The steam is allowed to condense inside the cavity and thereby hydrate the cement and/or MTA.

In another embodiment, the carrier 100 is provided with one or more openings that are sealed with a plug (e.g., a silicone plug). A dispensing device (e.g., a hypodermic needle) may be inserted through the plug to hydrate the cement within the carrier.

With respect to the hydration/activation steps described above, the sealant within the carrier 100 may be activated shortly before the mixed cement is dispensed (e.g., by the user of the carrier) or it may be (pre-hydrated/activated) by the manufacturer and/or seller of the carrier 2. In such pre-hydrated embodiments, the end caps preferably provide an air type seal for preventing or slowing down the dehydration/deactivation of the sealant.

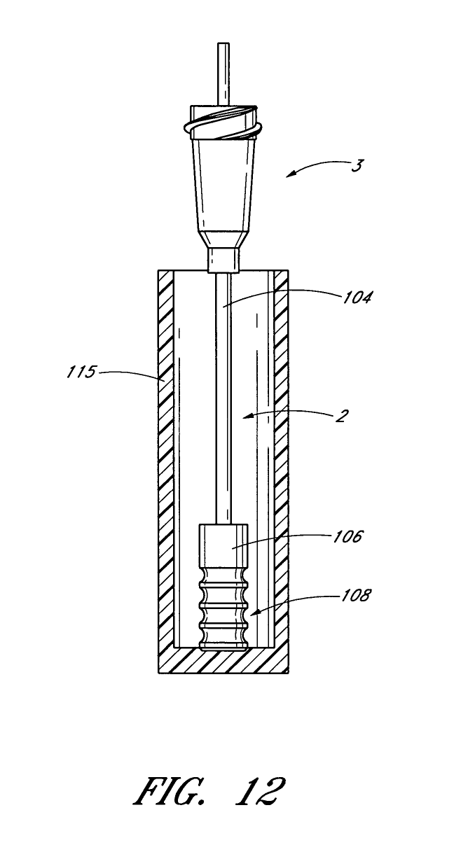

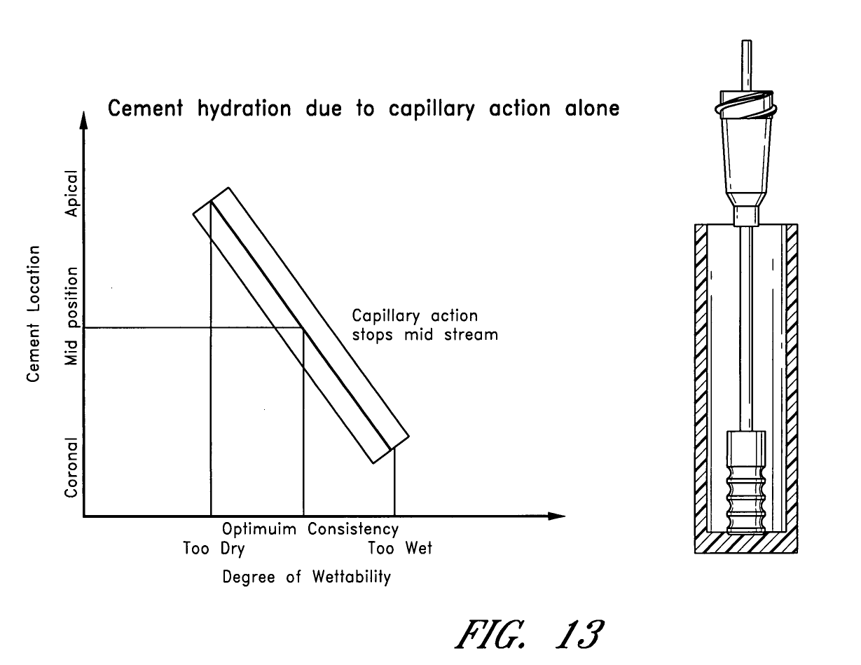

Another exemplary embodiment comprising a first hydration step and preferably a second hydration step will now be described with reference to FIGS. 12-14. As shown in the illustrated embodiment, in a first hydration step a tip 2 containing MTA is placed inside the vial 115 without removing the front cap 8. Front cap 8 is preferably made from a hydrophilic material, such as, for example, Porex. It is presently believed that the cap 8 serves two functions: (i) it allows the hydration process to start without removal of the cap 8, and thereby prevents the powder from getting out of the tip 2 and inside the vial 115 (ii) due to wicking action, it retains enough water that when the tip 2 is placed upside down during second step, it provides adequate hydration. During the first step, cement hydrates partially (e.g., in one embodiment only approximately 0.400″ high) inside the tip 2 due to capillary action, however, the remainder of the dry MTA is not hydrated. See FIG. 13. During a second hydration step the object is to hydrate the remainder of the cement via gravity action, and remove excess water from the coronal aspect (distal portion 106) of the tip 2. This can be accomplished by placing the tip 2 substantially inverting either in an empty vial and/or water filled vial as the back end 106 of the tip 2 can also be formed from a hydrophilic material such as porex.

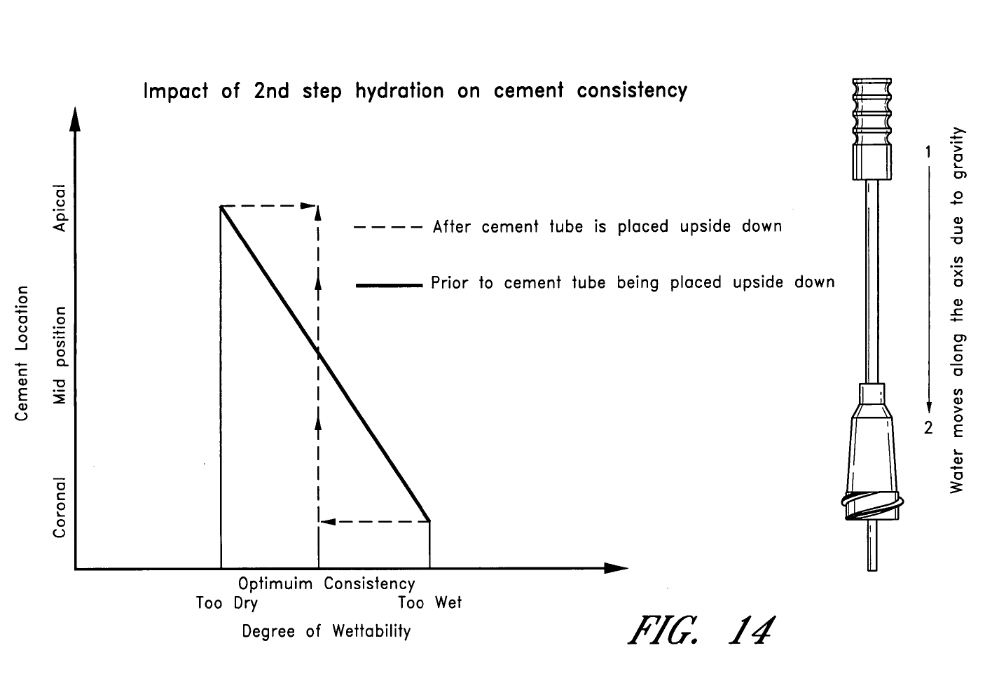

In the preferred embodiment as shown in FIG. 14, the tip 8 is placed substantially upside down, and the force of gravity causes water to migrate from coronal aspect 106 of the tip 2 to apical aspect 104 of the tip 2 as shown in the accompanying graph. In a modified embodiment, the excess water is drained from the coronal aspect 106 and it moves towards apical end 104 when the tip 2 containing the sealant is placed substantially upside down. This can be further aided by the capillary action of a porous hydrophilic material rod 5 placed inside the water as shown in FIG. 14, this type of embodiment may be particularly beneficial in cases when the tip 2 is exceptionally long.

It should be appreciate that while in the second step the carrier is described as being substantially inverted or substantially upside down other orientations can be used depending upon the configuration of the carrier. For example, if the carrier includes a bent portion the carrier can be rotated (e.g., by 45 degrees) such that gravity causes the liquid to drain towards the portions of the sealant on the other side of the bent portion.

After the sealant is hydrated using any one of the aforementioned methods and/or modification and/or combination thereof, the hydrated/activated cement and/or MTA is preferably pushed out of the cavity 1 using a dispensing device. Preferred embodiments of a dispensing device will now be described. However, it should be appreciated that can be a multitude of mechanisms that can be used to advance a rod 5 or other type of pushing device to dispense the hydrated powder. A person skilled in the art will recognize various other tools or mechanisms that are manual, automatic or a combination of both, to force the hydrated powder out of the carrier's cavity 1. Some of the particularly advantageous devices and methods are summarized below.

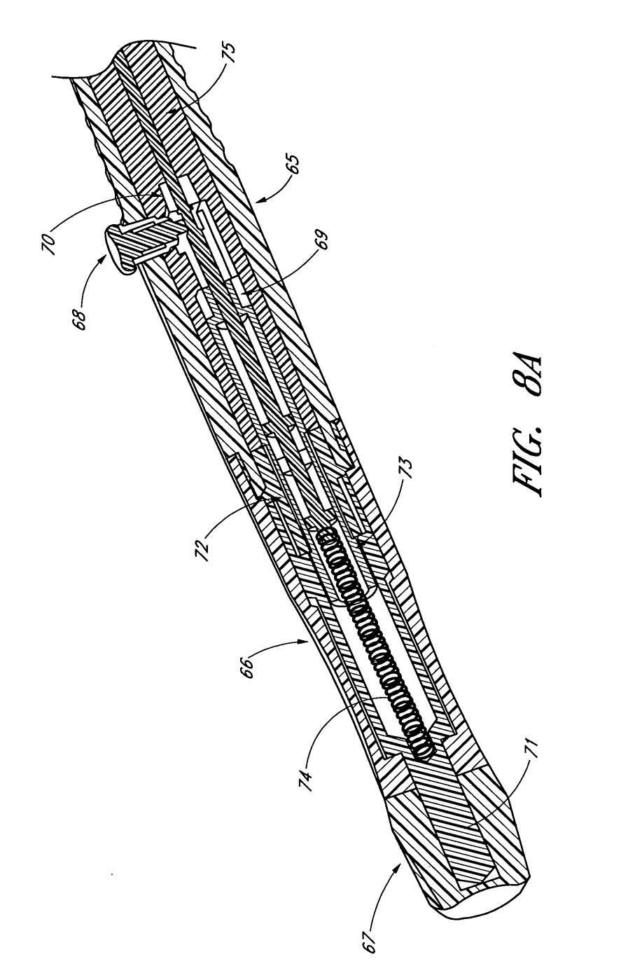

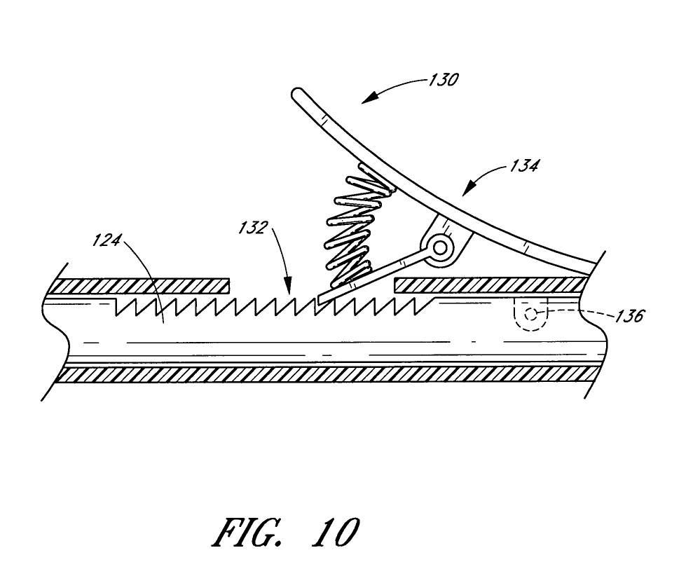

In one embodiment, the carrier 2 is connected to a syringe like-mechanism which includes an actuator for pushing the push rod 5 through and a connector for connecting to the carrier plug 3. In a modified embodiment, the push rod may be part of the syringe like-mechanism and/or the syringe like mechanism may be combined with the carrier. For example, FIGS. 1C and 9 illustrates an exemplary embodiment of a syringe like mechanism. A housing 120 with finger grips 122 is attached to the carrier (see FIG. 1C). As shown in FIG. 9, a plunger 124 is coupled to the push-rod 5 and may be inserted through a lumen 126 extending through the housing. The plunger preferably includes key taps which extend through slots formed in the housing 120. The housing 120 preferably includes graduations 128 along a slot 130 formed in the housing 120 to indicate the amount of sealant that has been pushed through the carrier 2. FIG. 10 illustrates part of a modified embodiment of the dispensing mechanism described with reference to FIGS. 1C and 9, which utilizes a ratchet mechanism 130 to control the movement of the plunger 124 with respect to the housing 120. The ratchet-mechanism 130 of the illustrated embodiment generally comprises a series of ridges or grooves 132 formed on a portion of the plunger 124 and a latch mechanism 130 pivotally mounted at a pivot point 136 on the housing 120. In this manner, the plunger 124 can be advanced in a ratchet-type manner through the housing 120.

In another embodiment, after the hydration process is completed, the user connects the hydrated carrier 2 to a delivery mechanism that includes a metering device for pre-selecting the amount of cement dispensed through the carrier 2. The distal end 106 of the carrier may then be placed into the target location (e.g., the root canal) and the rod 5 is pushed forward until it movement is limited by the metering device. As the rod 5 is advanced, the cement is forced out of the carrier 2 into the root canal and/or into other locations as intended.

An example of such an embodiment is shown in FIG. 2, which is an exploded view of a syringe dispensing mechanism 200 which provides tactile feedback The mechanism comprises of a thumb disk 9, a metering wheel 10, a ball and spring assembly or ball plunger 11, a barrel 12, a piston 13, a compression spring 14, an alignment sleeve 15, and an dispensing needle connector 16. All of the components of the syringe delivery mechanism 100 can be made out of either metal and/or engineering plastic and/or combination thereof. If components such as ball plunger assembly 11, piston 13, and barrel 12 are made out of metal, they can be coated with friction reducing coatings such as amorphous diamond coating, hard anodizing etc. The piston 13 has anti-rotational features 17 on its external surface that engage corresponding internal features of the barrel 12. These features prevent accidental release of slurry if thumb push button is accidentally rotated, and is not being pushed axially. The force attenuation spring 14 provides tactile sensation during slurry dispensing process. The force attenuation spring 14 can have variable rate such that it provides higher spring force initially and reduced amount of force during later stages.

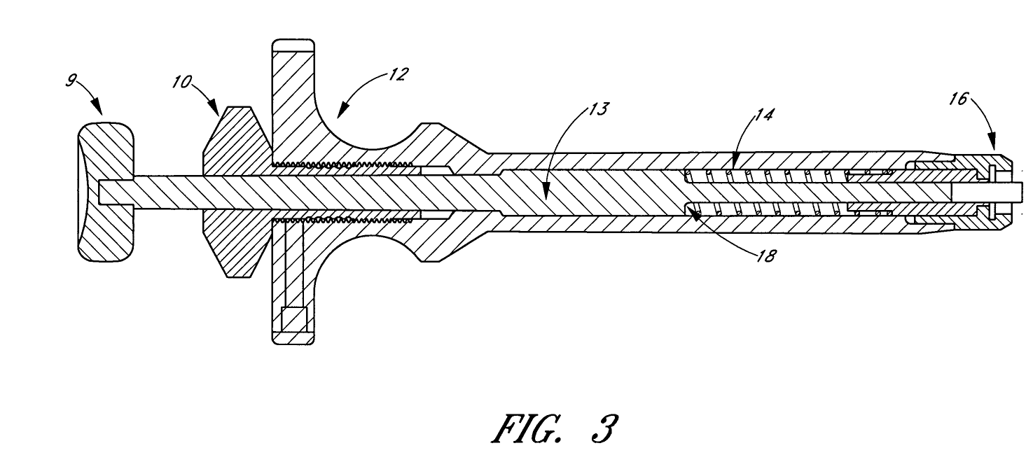

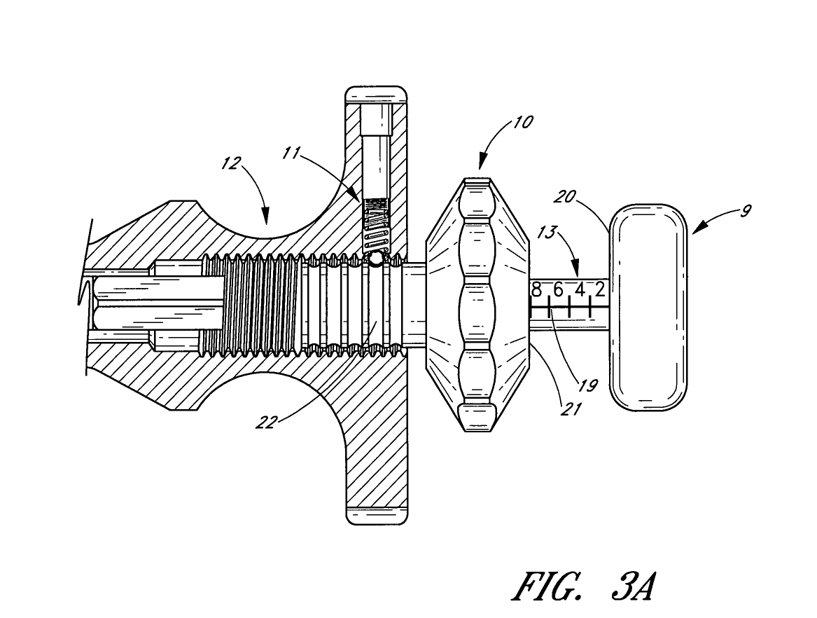

In one embodiment, the mechanism 200 is assembled by threading the metering wheel 10 into the barrel 12. Then, the piston 13 is inserted from the apical side of the barrel 12 through the wheel 10 and is press fitted and/or threaded in the thumb disk 9. Thereafter, the compression spring 14 is dropped inside the barrel 12, and the assembly of the alignment sleeve 14 and dispensing needle connector 15 is press fitted, snap fitted and/or threaded to the barrel 12. Finally, the ball plunger 11 is threaded into the barrel 12 so that it engages the grooves 22 of the metering wheel 10. See FIG. 3A.

FIG. 3 is an enlarged cross-section view of the proximal end of the syringe dispensing mechanism 200. As shown, the compression spring 14 pushes up against a shoulder 18 of the piston 13 away from the dispensing needle connector 16. When the user pushes the thumb disk 9 the piston 13 moves inwardly and compresses the spring 14, which provides resistance to the axial movement of the piston to allow for a better tactile sense while the piston 13 and/or the push rod 5 pushes out the cement from the carrier cavity 1 previously shown in FIG. 1. The metering wheel 10 provides a stop for the thumb disk 9. The metering wheel 10 can be rotated out of the barrel 12 to a specific measurement shown on graduations 19 to allow for a controllable amount of cement delivered as shown on FIG. 3A. The distance between a bottom surface 20 of the thumb disk 9 and a top surface 21 of the metering wheel 10 is equivalent to the amount of cement and/or MTA that will be dispensed. The ball plunger 11 is an optional component that provides tactile sensation when the metering wheel 10 reaches a particular dosage. The grooves 22 of the metering wheel 10 engage the ball plunger 11, which provides tactile feel. These grooves 22 are spaced apart to a desired distance that would correlate to the specific measurement 19 on the piston 13.

In the modified embodiment, the carrier 2 and dispensing mechanism are made into a single unit, the user removes the whole unit after the powder has been hydrated using any one of the aforementioned techniques and pushes the backend of the unit forward, which in turn pushes the plunger 5. The forward motion of the plunger 5 causes the powder to be expelled out of the dispensing syringe 2.

In the another embodiment, the carrier 2 is connected or formed with a dispensing mechanism that includes a ratcheting mechanism 2. In such an embodiment, as the user presses a pushbutton, the pushrod moves in an incremental manner, depending on the distance between the ratcheting teeth, and thereby pushes the powder.

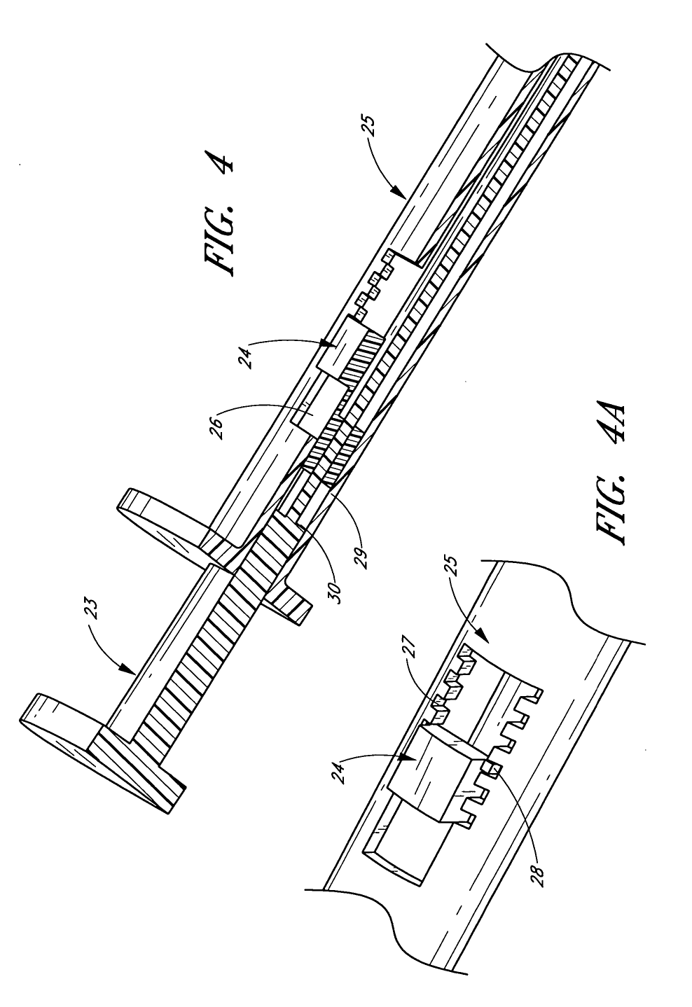

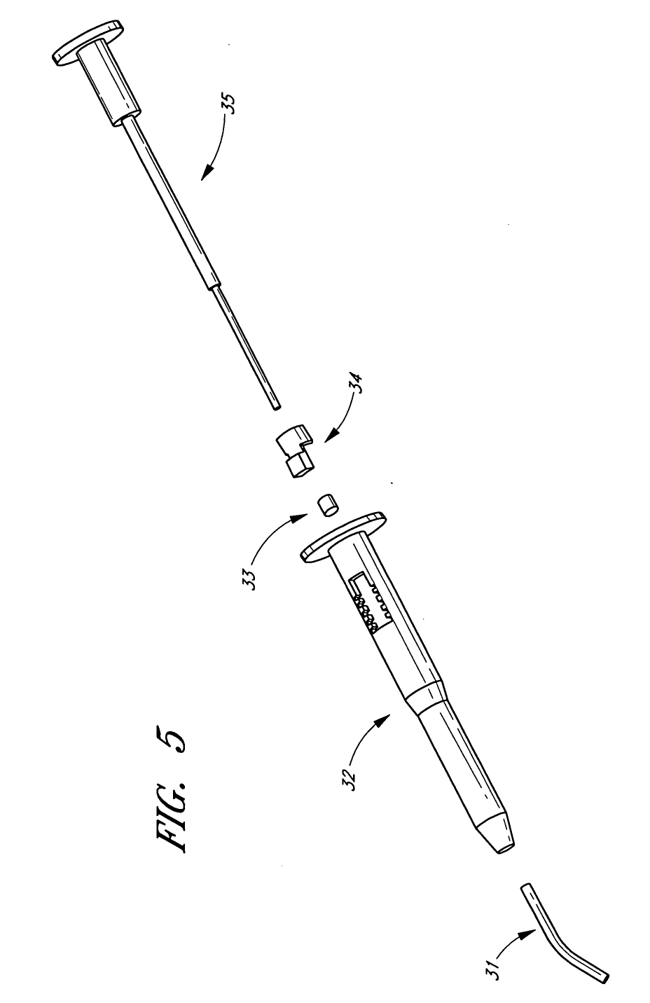

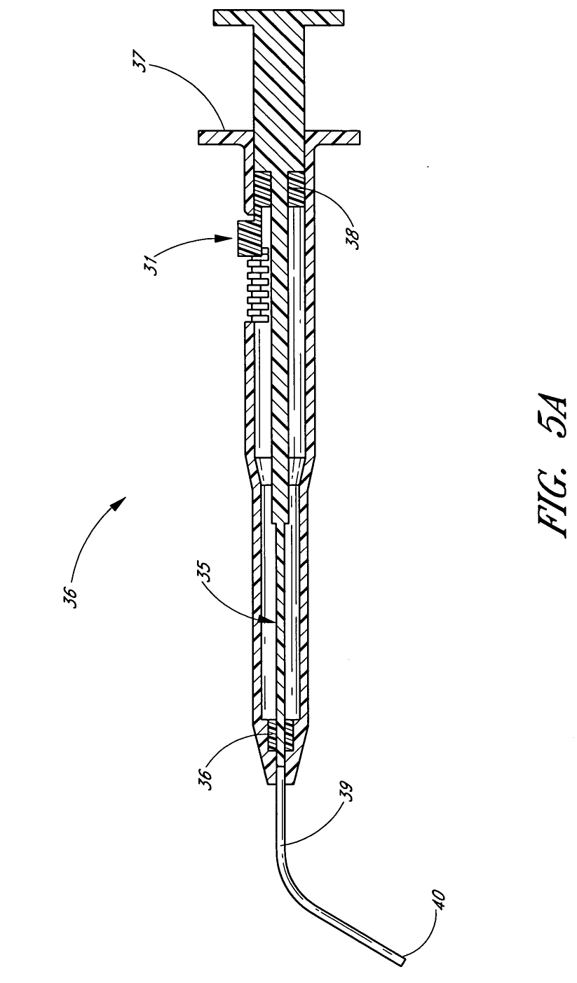

FIG. 4 is an example of a dispensing mechanism that utilizes a ratcheting mechanism. In this embodiment, the dispensing mechanism comprises a piston 23, a lever 24, and a barrel 25. The barrel 25 has a cutout 26 with grooves 27. The lever 24 moves axially to a specific location until its protrusion/s 28 lock into the grooves 27 as shown in FIG. 4A. Once the lever 24 is locked in place, the user pushes the piston 23 inwardly until it hits the surface 29 of the lever 24. The distance between the surface 29 of the lever 24 and the shoulder 30 of the piston 23 is equivalent to the amount of slurry that will be dispensed.

As mentioned above, the carrier and the dispensing mechanism may be made into a single unit. In such an embodiment, the carrier and the dispensing mechanism may be package together in a package. The user may remove the dispensing mechanism from the package and hydrate the carrier using one of the techniques described above. The dispensing mechanism may then used to remove the cement from the carrier.

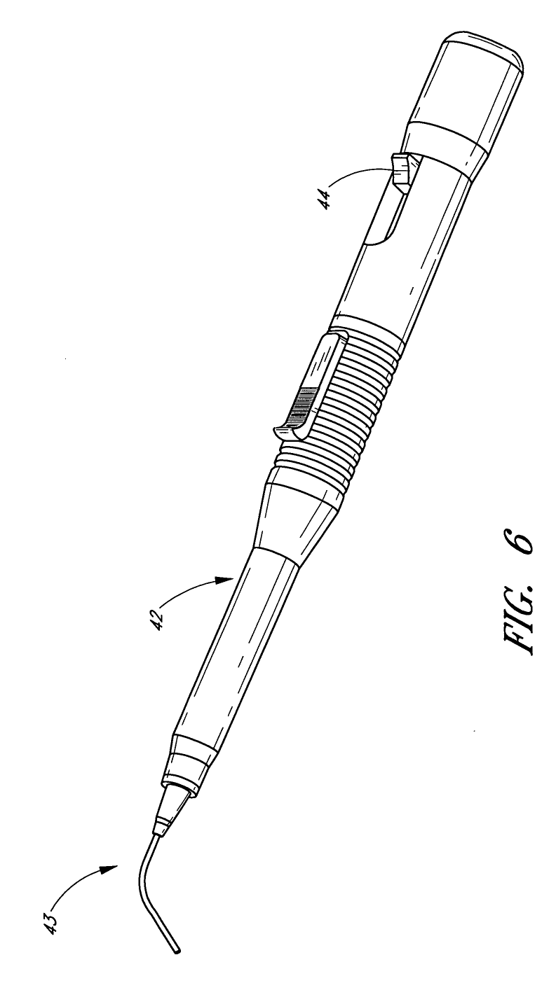

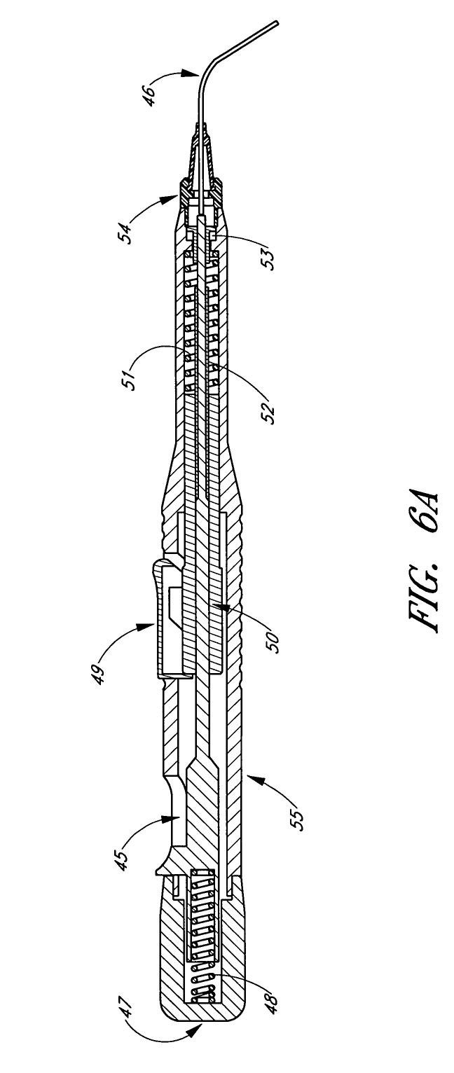

FIG. 5 is an isometric exploded view of an example embodiment of a single component syringe and cement carrier. This device comprises of a carrier 31, a barrel 32, an optional retentive sleeve 33, an optional lever or stop 34, and a piston 35. The carrier shape and size allows for its insertion into the root canal and it can be made of same materials as described previously on FIG. 1. The carrier 31 can be press fitted, bonded or light cured into the barrel 32 or it can be part of the barrel 32 body. The optional retentive sleeve 33 is inserted into the cavity 36 of the barrel 32 to hold the piston 35 in place as shown in FIG. 5A. An alternative method of retention is to use an o-ring not shown or the lever 34 as the retentive feature. The lever 34 is an optional component that is used as stop for the piston to control the amount of solution to be delivered. This stop feature can also be incorporated in the barrel's 32 body, such the top surface 37 or an internal shoulder, not shown. The piston 35 is inserted through the lever/stop opening 38 and into the carrier's cavity 39. The dry powder is then loaded into the carrier's cavity 39 and finally the apical end tip 40 is sealed with a cap or a hydrophilic and/or porous enclosure, not shown, or any other suitable method for packaging prior to use. Alternatively a fixture or a pin can be used to transmit vibrations to the carrier prior to full assembly of the components.

In another embodiment, the dispensing mechanism includes a kinetic accelerating mechanism, and when user, for example, presses the pushbutton, the pushrod moves forward at a high speed, which in turn forces the powder out of the carrier. In some embodiments, the mechanism utilizes a spring to provide the kinetic energy in other embodiments the mechanism utilizes a gas cylinder to provide the kinetic energy.

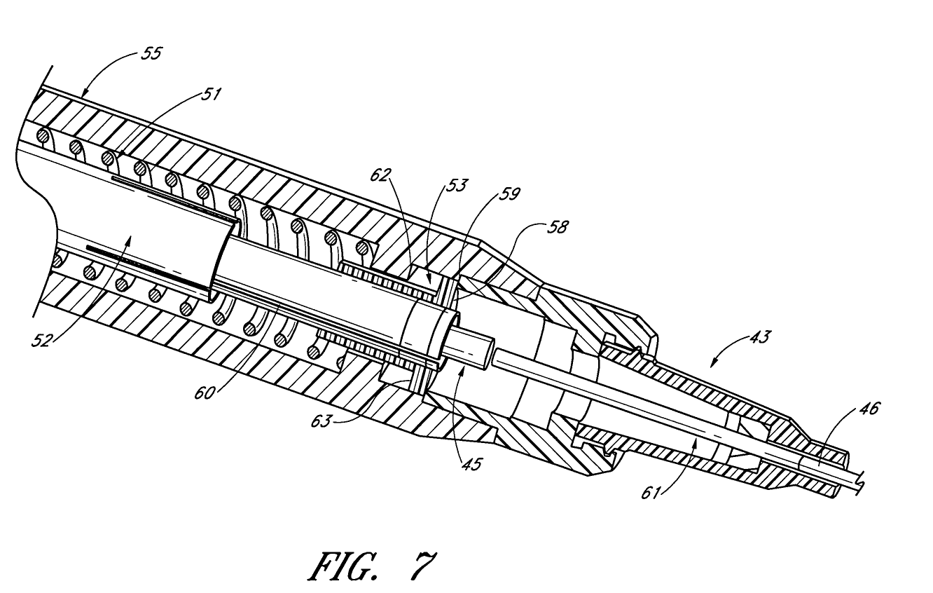

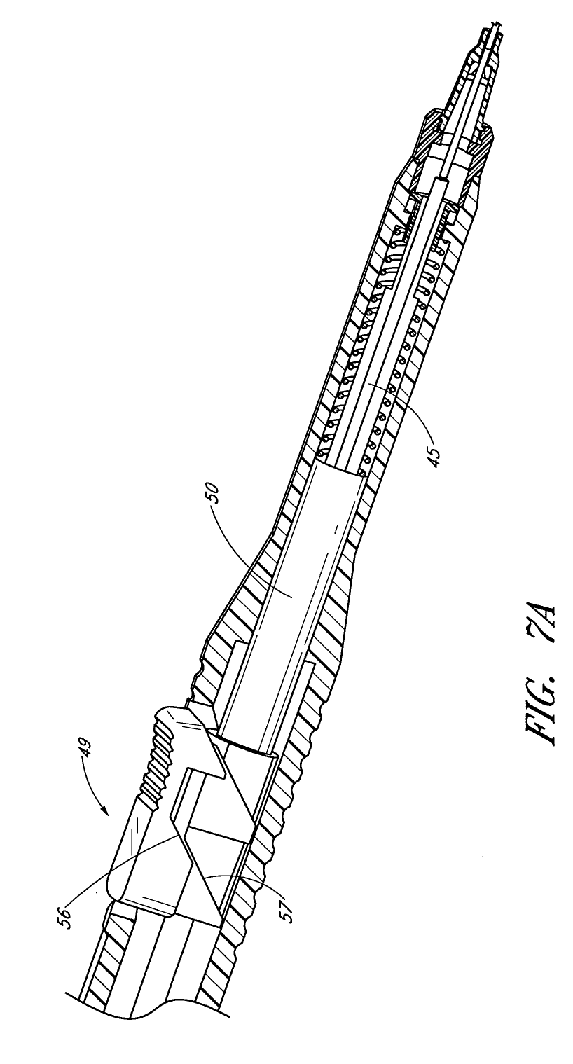

FIG. 6 is an isometric view of an example of an embodiment that utilizes an accelerating mechanism which is similar to mechanical pencil with compression spring dispensing device. The device 42 is assembled with a carrier 43 that preferably has the same features as previously described in FIG. 1. The lever feature 44 can be part of the piston 45 that pushes the slurry-like material out of the carrier's cavity 46 as shown in FIG. 6A. The lever feature 44 is used to retract the piston 45, which causes the piston spring to compress. This spring will further assist the piston 45 to move forward once the collet mechanism opens up as described in FIG. 7. This device also comprises of an end cap 47, a piston compression spring 48, a button 49, a collet plunger 50, collet compression spring 51, a collet 52, a locking bushing 53, a carrier adapter 54, and a body 55.

FIGS. 7 and 7A are an isometric cross-section view of the front end of the accelerating mechanism with the compression spring dispensing device. The button 49 is pushed perpendicularly to the axis of the piston 45, which causes the angled surfaces 56 of the button 49 to contact the angled surfaces 57 of the collet plunger 50 making it to move forward. This motion causes the collet 52 and the locking bushing 53 to also move forward. The locking bushing 53 stops from moving forward when the surface 58 contacts the surface 59 of the carrier adapter 54. The distance between the surface 62 of the body 55 and the surface 63 of the locking bushing 53 is the amount of travel of the piston 45 prior to the collet to open. This amount of travel is what makes the incremental dispensing of cement into the root canal every time the end user pushes down the button 49. Since the collet 52 moves away from surface 58, the slots 60 open up. It is at this time that the piston 45 assisted by the piston spring 48 shown in FIG. 6A moves out of the collet 52 pushing the push rod 61 forward, which causes the slurry-like material to come out of the cavity 46.

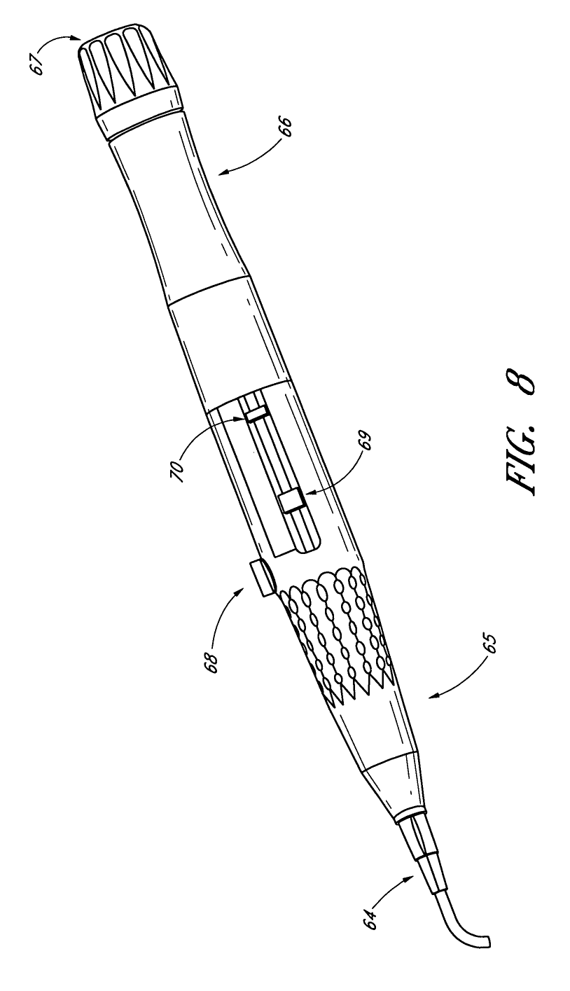

In another embodiment of a dispensing mechanism, the stored energy of a spring is transmitted via a lead screw to the dispensing syringe as soon as the actuating member is pushed. FIG. 8 is an isometric view of an exemplary embodiment of such a lead-screw dispensing mechanism. The device is assembled with a carrier 64 that has the same features as previously described in FIG. 1. The carrier 64 is connected to the front case 65, which is connected to the rear case 66. The rear case 66 is then connected to a knob 67. Other features that can be seen from the outer surfaces of the device are a button 68, a key indicator 69 and a rod indicator 70. The knob 67 is rotated counter clockwise to turn the adjustment shaft 71, which causes the lead nut 72 to rotate as shown in FIG. 8A. The lead nut 72 rotation causes the lead screw 73 to move forward until it hits the key indicator 69. Then, the knob 67 is turn clockwise to preload the spring 74 and when the pushbutton is depressed, it causes the lead screw 73 to become disengaged and traverse forward. This forward motion is then transmitted via the pushrod 75 to the slurry.

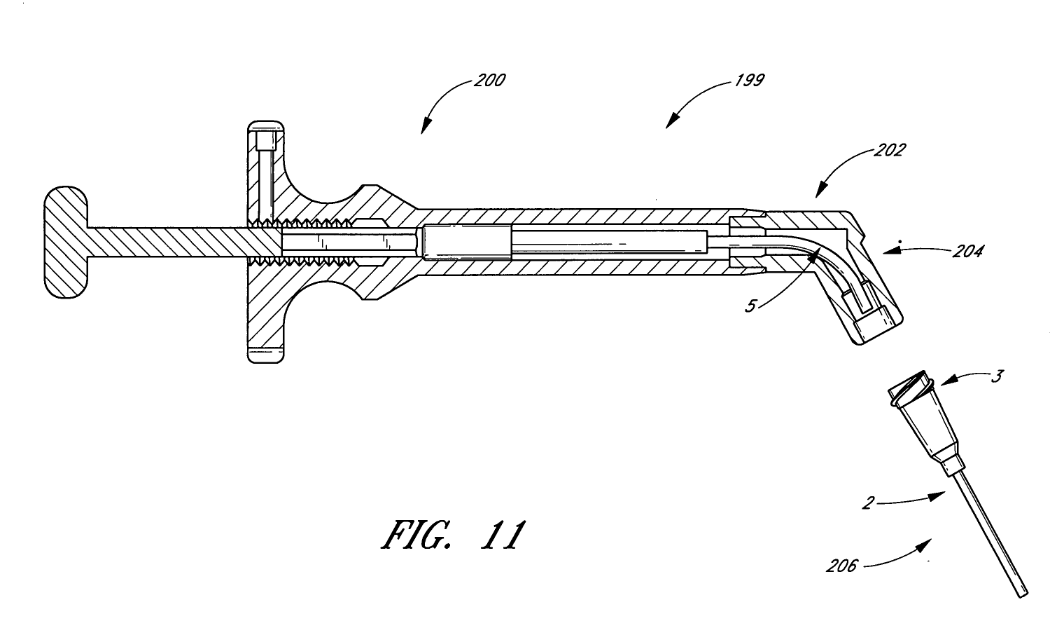

FIG. 11 illustrates another embodiment of a dispensing mechanism 199. This embodiment includes a proximal end 200 arranged in a manner similar to the mechanism of FIGS. 3 and 3A. However in this embodiment the distal end 202 includes a bent nose 204. Accordingly, the carrier 2 may be formed from a straight member 206. The push rod 5 is preferably formed from a bendable material such as Nitinol or engineering plastics such that it can navigate the turn within the bent nose. In modified embodiments, the mechanism may include various gears or levers for translating movement from the proximal end 200 of the mechanism through the bent nose 204 to the carrier 2.

The embodiments described above may be packaged and sold in a variety of combinations and sub-combinations. For example, in one embodiment, the carrier unit 2 is sold as a pre-package unit filled with deactivated or activated sealant. In such an embodiment, the carrier unit 2 may be considered a disposable unit that is configured to mate with a dispensing mechanism configured for multiple uses. The carrier unit 2 may also be sold or package with components used to activate the sealant (e.g., a vial, wick etc.). The carrier unit 2 may include only the carrier 2 with proximal and distal plugs or caps or it may include various combinations or sub-combinations of the push rod 5 (or a portion thereof), the hub, sleeve etc. In other embodiments, the carrier 2 and the dispensing unit are sold and packaged together with the activated or deactivated sealant positioned within the carrier 2. In such embodiments, the carrier 2 and the dispensing unit may be disposable and intended for a single use. In other embodiments, the carrier 2 and the dispensing unit may be returned to the manufacturer for cleaning and/or refilling.

In yet another embodiment, the carrier unit alone can also be sold separately. This may be advantageous in certain confined situations such as trying to insert MTA in a root canal in a posterior maxilla. In this type of situation, a dentist can push directly on the push rod 5 and expel cement.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. For example, it is contemplated that various combination or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention.

1. A method for preparing and inserting a sealant into a root canal, the method comprising:
activating an un-activated sealant while it is positioned at least partially within an elongated tubular body having a distal end configured to fit within the root canal;
inserting the distal end of elongated tubular body into the root canal; and
advancing a plunger through the elongated tubular body to disperse the activated sealant into the root canal.

2. The method of claim 1, wherein activating the un-activated sealant comprises hydrating the sealant.

3. The method of claim 2, wherein the un-activated sealant comprises a dry cement.

4. The method of claim 2, wherein activating the un-activated sealant comprising positioning the distal end or a proximal end of the elongated tubular body into a fluid containing a hydrating solution for a first period of time.

5. The method of claim 4, further comprising substantially inverting the elongated tubular body after inserting the distal end or proximal end of the elongated tubular body into the fluid and maintaining the elongated tubular body in the substantially inverted position for a second period of time to hydrate portions of the sealant not hydrated during the first period of time.

6. The method of claim 1, further comprising coupling the elongated tubular body to a dispensing mechanism comprising a housing configured to be grasped by a user and an actuating mechanism configured to advance the plunger through the elongated tubular body while keeping the elongated tubular body stationary with respect to the housing.

7. The method of claim 1, further comprising bending the elongated tubular body before the distal end is inserted into the root canal.

8. The method of claim 1, further comprising bending the elongated tubular body as the distal end is inserted into the root canal.

9. The method of claim 1, further comprising providing the first end of the carrier with a cap at least partially formed of a hydrophilic material.

10. A method for preparing and inserting a sealant into a lumen within a patient, the method comprising:
providing an carrier that defines a lumen having a first end and a second end and an un-activated sealant positioned within the lumen;
inserting the first end of the carrier into a container containing an activating solution;
leaving the first end of the carrier in the container for a first period of time sufficient to activate a first portion of the sealant while a second portion of the sealant remains un-activated, the first portion of the sealant being nearer the first end of the carrier as compared to the second portion;
substantially inverting the carrier; and
maintaining the carrier in the substantially inverted position for a second period of time that is sufficient to activate the second portion of the sealant.

11. The method of claim 10, further comprising providing the first end of the carrier with a cap at least partially formed of a hydrophilic material.

12. The method of claim 10, further comprising inserting the second end of the carrier into a container comprising an activating solution.

13. The method of claim 12, further comprising providing the second end of the carrier with a cap at least partially formed of a hydrophilic material.

14. A carrier configured to store and dispense a dental cement into a root canal, the carrier comprising:
a tubular body comprising a first open end and a second open end, the tubular body being defined at least in part by a tubular wall that defines a lumen and is substantially impermeable to water;
a dry dental cement positioned within the lumen of the tubular body;
means for closing the first open end of the tubular body; and
means for closing the second open end of the tubular body.

15. A carrier as in claim 14, further comprising a push rod positioned within the lumen of the tubular body.

16. A carrier as in claim 14, wherein the tubular body includes a first portion, a second portion and a bent portion between the first and second portions.

17. A carrier as in claim 16, wherein the carrier further comprises a flexible push rod positioned within the lumen of the tubular body.

18. A mechanism for dispensing a hydrated dental cement, the mechanism comprising:
a tubular body comprising a first open end and a second open end, the tubular body being defined at least in part by a tubular wall that defines a lumen;
a push rod positioned within the tubular body;
dry dental cement positioned within the tubular body between the push rod and the first open end of the tubular body;
a housing coupled to the second end of the tubular body, the housing configured to be grasped by a user, the housing further comprising a actuating mechanism configured advance the push rod through the tubular body to dispense the dental cement from the first open end while keeping the tubular body stationary with respect to the housing.

19. The mechanism as in claim 18, wherein the tubular body has a bent portion and at least a portion of the push rod is flexible to navigate the bent portion.

20. The mechanism as in claim 18, wherein the actuating mechanism includes a ratchet-type mechanism that is configured to limit movement of the push-rod.

21. The mechanism as in claim 18, further comprising means for determining the amount of cement dispensed from the distal end of the tubular body as the push rod is advanced.
